(19) United States
(12) Patent Application Publication
(10) Pub. No.: US 2004/0153209 A1
(43) Pub. Date: Aug. 5, 2004

(54) Reusable container for the transfer of goods and for locating in a reusable container circulating system

(76) Inventor: Stefan Müller, Giggenhausen (DE)

Correspondence Address: Kenneth J Johnson, Marsh Fischmann & Breyfogle, Suite 411, 3151 South Vaughn Way, Aurora, CO, 80014, US

(21) Appl. No.: 10/476,992

(22) PCT Filed: Jan. 23, 2003
(86) PCT No.: PCT/EP03/00704

(30) Foreign Application Priority Data
Jan. 23, 2002 (DE) 102 02 477.4

(51) Int. Cl. G06F 7/00

(52) U.S. Cl. 700/229

(57) ABSTRACT

A returnable container for merchandise transloading and for location determination and/or identification in a returnable container circulation system in which the container (1) is circulated between various stations, including issue station of the circulation system, production sites, suppliers, traders, points of sale, storage and cleaning stations and the like, the container being provided with an identification means that contains specific information items for identifying the container and/or its contents and determining its location, where the read data are collected and evaluated at a central and/or local station, is characterized in that the identification means is constituted by a carrier that can be arranged on the container (1) and is provided with a specific colour code that individualizes the container.

The invention relates to a returnable container for merchandise transloading that is especially intended for determining the location of the container in a returnable container circulation system. The returnable container in accordance with the preamble of Claim 1 is used particularly for the transport of fruit and vegetables. For this purpose use is for the most part made of containers that are designed in the manner of a case, that is to say, consist of four walls and a case bottom. Very often these cases are designed as folding cases, where the side walls are articulated to the box bottom and can be folded inwards and onto the bottom.

Returnable containers made of plastic material are being used on an ever larger scale for merchandise transloading. In this case use may be made of boxes, but also pallets, trays and crate- or container-like receptacles that usually consist of four side wall and a box bottom. With a view to saving space when the containers are returned, the side walls are preferably designed to be collapsible, so that the side walls can be folded inwards and down onto the container bottom with consequent reduction of their volume. In this connection use is made of many different designs for such containers, where the side walls are articulated to the container bottom either by means of ordinary hinges or film hinges. When in their upright position to form the container, the side walls are locked to each other by means of conventional locking hooks and locking catches, so that a stable container is assured.

Such returnable containers are particularly suitable for use in so-called returnable container circulation systems by means of which the containers are circulated between two different stations within a so-called pool system. For example, the returnable containers are delivered by the service provider of the pool system to the merchandise producers, possibly a fruit plantation in Portugal, who then pack the whole of the merchandise, oranges say, in the returnable containers. By the insertion of appropriate intermediaries, these returnable containers with the merchandise stowed in them, oranges in our example, can then be delivered to points of sale in many different countries, where the merchandise is sold. The seller will then either send the empty returnable containers to other producers or return them to the pool system service provider, whence the containers, if necessary after an appropriate cleaning process, are then again sent out to different producers.

These circulation systems have proved successful, and in these circulation systems, depending on the number of countries that are covered by them, there now circulate hundreds of thousands of returnable containers. It is therefore readily obvious that, for the purposes of controlling the logistics, it is important for the pool system service provider to monitor the number and type and also the location pro tempore of the returnable containers that are circulating—in Europe, say—between producers, intermediaries and points of sale, so that he will be able to decide in good time where, when and in what number the empty returnable containers can then again be delivered to the different producers.

With a view to locating such containers in a returnable container circulation system it is known to make use of so-called transponders that are provided with bar codes that can be scanned. These transponders, which are fitted to the containers, may also be equipped with antennas, so that the cases and/or containers can be located by means of radio. But the drawbacks of this transponder-container system consist of the fact that the scanning processes have a duration of the order of from two to three minutes and therefore occupy a relatively long period of time, which decidedly reduces the efficiency of such a control system. As far as frequencies are concerned, moreover, the service provider is limited to the frequency distribution imposed by the authorities and the commercially utilizable frequencies have only a very limited transmission range, so that this system can be employed only within very narrow limits.

The present invention therefore sets out to create a container for location determination and identification in a returnable container circulation system that can be located in a quick, certain and unobjectionable manner. In particular, identification is to be effected in such a manner that, in addition to such container-specific data as, say, age of the container, number of circulation cycles, location of the container, it should be possible also to make available appropriate information about the type of merchandise they contain, deterioration dates, delivery times, etc. being cases in point.

According to the invention, this task is absolved by means of the characteristics set out in the characterizing part of Claim 1 hereinbelow, while advantageous further developments are described in the dependent Claims relating to the container itself. The invention also concerns a colour code for such a container, as well as a container location system to locate such containers that are equipped with a colour code and/or appropriate colour codes. According to the invention, the returnable container for merchandise transloading serves for the purpose of locating the individual containers provided with a colour code, where the colour code is so designed and so constituted as to specify the individual container. This can be obtained by means of purposeful selection of various colours in combination with specific colour gradations and/or chrominances, since each colour can be subdivided into chrominances, so that, using an appropriate optical colour measurement instrument, a container can be identified in accordance with the specific chrominance measured in each case. This special colour code is coupled with a container number, so that the locally evaluated data can be utilized also by a central station.

Advantageously, the colour codes and/or colour code carriers are provided on at least one side wall, but preferably on all the side walls. When at a particular station, the point of sale for example, the container is transported on a conveyor that is equipped with an appropriate camera, the container will be automatically identified in loco and therefore individually represented, i.e. located, so that the data can be passed to a central station, where, as it were, the location of the container will be known at all times. In this way it becomes possible to monitor the progress of the container within the pool system. This is very important for the logistics of a returnable container circulation system, because appropriate decision regarding the subsequent use of any one or several containers can be made in good time.

Advantageously, the container will be identified by means of cameras installed in the transport system at the point of sale. In this connection and with a view to rendering possible a sure evaluation of the container, it is preferred that each haulage track should be provided with two cameras arranged opposite each other, the cameras being in each case oriented in such a manner in the direction of the containers handled by the haulage track in question as to permit them to recognize and evaluate the colour code and/or the colour code carrier. In this connection it will be advantageous if each of the side walls of the container is provided with the appropriate colour code and/or colour code carrier, since one cannot expect the operating personnel to assure a precise orientation of the containers on the haulage track. When the colour codes and/or the colour code carriers are arranged in this manner on a container, one makes sure that, no matter what the position of the container, it can be recognized and identified in a certain manner by the code reading device. In this connection it is possible that the cameras, due to the presence of an optical colour-reading or colour-measuring instrument, will not only recognize and evaluate the special colour or the special colours (whenever several sections with different colours are used for identification purposes), but also the structure of the geometry of the colour code carrier, that is to say, one or more annular areas and the number of the sections, so that in case of need it is possible to read also additional information regarding the container and/or obtain an appropriately improved reading for identification purposes.

It is advantageous when the cameras arranged on stands on both sides of the haulage track are accommodated in the stands of a portal straddling the haulage track and through which the containers are being transported. Given such a portal-type arrangement, it is possible to read boxes arranged on pallets, since two rows of boxes are normally arranged side by side on a pallet.

The read data can either be collected in a local store or be transferred directly into a central store. The central store is connected to a computer, so that appropriate evaluation of the data is rendered possible. Advantageously, this computer will be arranged within the pool system. Together with the evaluation of the colour code, the local output may also comprise the number of the container, so that, possibly at the sales point, other information about the container may be added, whether it is empty or contains new merchandise for example, and passed on to the central station. In this case even a changed content of merchandise can be monitored any time. This is advantageous, because the central station will then be in a position to move the containers that have been ascertained locally, at the point of sale for example, to some other station, possibly when the empty state of the containers has been ascertained at the point of sale and reported to the central station. The information can be passed to the central station, for example, by means of a data connection, i.e. an appropriate data link, but also by means of e-mail and other forms of communication.

A preferred embodiment of the invention will now be described with the help of the drawing, wherein, albeit in a purely schematic manner,

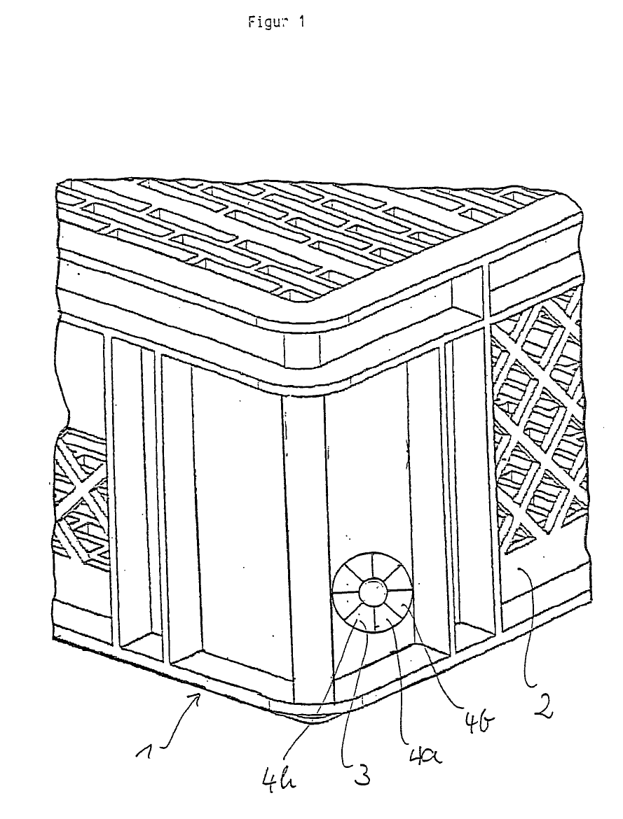

FIG. 1 shows a partial view of a container that has been provided with a colour code one of its side face, and

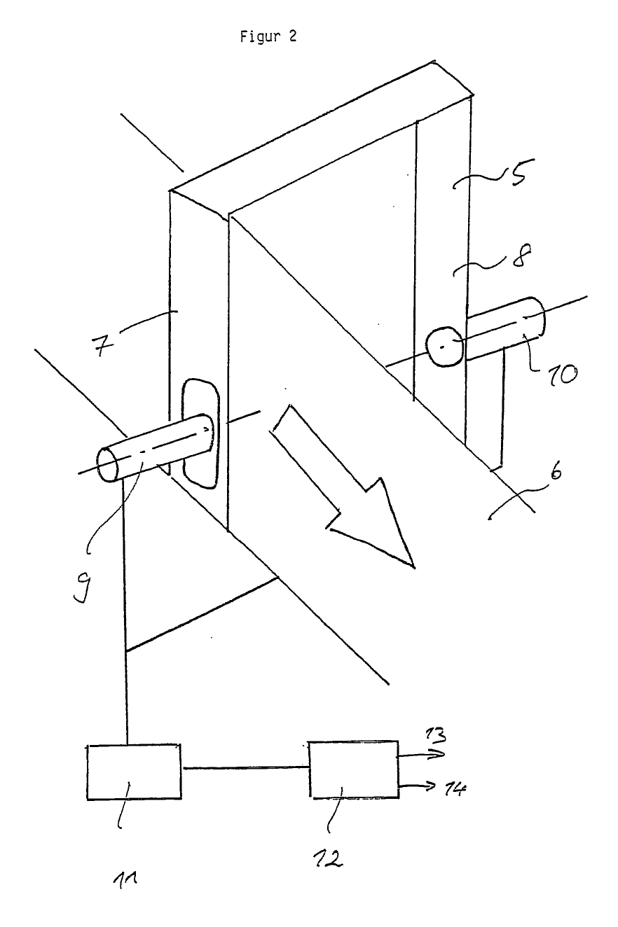

FIG. 2 shows a schematic representation of an identification reading device at a haulage track.

FIG. 1 shows a perspective view of the corner region of a container 1 of which the side wall, indicated by the reference number 2, is provided with a colour code 3. To this end there is provided a carrier that may be clipped onto the side wall or attached thereto by gluing. This carrier, which in this case is constituted by a circular disk, consists of several sections 4a to 4h that are arranged on an annular surface and can be covered with different colours. The colour composition and/or the chosen chrominances are prepared in such a manner as to enable them to identify a special individual container, which can be done with the help of a camera and an appropriate colour measurement instrument. Consequently the container can always be located when it passes a point where an appropriate identification reading device with cameras is installed, so that the path that the container follows in the poll circulation system can be monitored.

FIG. 2 shows an identification reading device in the manner of a portal 5 that straddles a haulage track 6, which could consist, for example, of an endless conveyor belt or transport rollers. At each of the stands 7 and 8 of the portal there is provided a camera, respectively, 9 and 10. The cameras 9 and 10 are orientated in the direction of the haulage track 6 in such a manner that, whenever a container passes under the portal 5, as to point to the colour code and can therefore read it. Due to the fact that a camera is provided on each side of the portal, a perfect identification of the special container becomes possible in the case in which a colour code is provided on each of the side walls of the container. The information obtained in this manner may be evaluated in any desired manner, that is to say, according to the type and design of the pool system. In the embodiment here illustrated the data photographed and measured and/or evaluated by the cameras 9 and 10 are collected in a store 11, which may be provided either at the centre or in loco. The data are then appropriately evaluated by a computer 12, the computer being also in a position to pass more detailed information to various stations of the pool circulation system for the purpose of controlling the circulation of the containers. This is indicated by the arrows 13 and 14.

1. A returnable container for merchandise transloading and for location determination and/or identification in a returnable container circulation system in which the container (1) is circulated between various stations, including issue station of the circulation system, production sites, suppliers, traders, points of sale, storage and cleaning stations and the like, the container being provided with an identification means that contains specific information items for identifying the container and/or its contents and determining its location, where the information can be interrogated by means of identity-reading devices and the ascertained data are collected and evaluated at a central and/or local station, characterized in that the identification means is constituted by a carrier that can be arranged on the container (1) and is provided with a specific colour code (3) that individualizes the container.

2. A container in accordance with claim 1, characterized in that the carrier is designed with a geometrically structured colour code (3) such that information items will be defined both by the colour code and the geometric structure.

3. A container in accordance with claim 1 or claim 2, characterized in that the colour code carrier is provided with a geometric structure subdivided into several sections (4a-4h), so that information items can be associated with the individual sections and/or the specific colours of the individual sections and downloaded by means of reading.

4. A container in accordance with any one of the preceding claims, characterized in that the carrier is constituted by a disk, where the sections (4a-4h) are constituted by disk segments and the disk is preferably circular.

5. A container in accordance with claim 4, characterized in that the disk is provided with at least one annular area subdivided into segments for the recording of information.

6. A container in accordance with claim 5, characterized in that several concentric annular area are provided on the disk.

7. A container in accordance with any one of claims 4 to 6, characterized in that the segments and/sections are equal to each other.

8. A container in accordance with any one of the preceding claims, characterized in that the carrier and/or the colour code is provided on at least one side wall of the container, preferably one each of the four side walls.

9. A container location system for containers in accordance with any one of the preceding claims, characterized in that the identity reading device is provided with at least one optical colour measurement instrument or is designed as an optical colour measurement instrument.

10. A system in accordance with claim 9, characterized in that the identity reading device is provided with at least one camera (9, 10) for reading the colour code and/or the colour code carrier.

11. A system in accordance with claim 10, characterized in that the structures read by the cameras (9, 10) are evaluated by means of colour measurement devices as far as the colour code is concerned.

12. A system in accordance with any one of claims 9 to 11, characterized in that there is provided at least one store (11) for the read data and at least one computer (12) for the data evaluation.

13. A system in accordance with any one of claims 9 to 12, characterized in that all the stations of the container location system are joined by a data network and that store and computer are preferably situated at the central station.

14. A system in accordance with any one of claims 9 to 13,, characterized in that the camera (9, 10) for detecting the colour code (3) is arranged on a stand (7, 8) by the side of the haulage track (6) for the containers (1) and that the containers transported along the haulage track are oriented for reading the colour code.

15. A system in accordance with claim 14, characterized in that a stand (7, 8) with cameras (9,10) is arranged on both sides of the haulage track (6).

16. A colour code in accordance with claim 14 or claim 15, characterized in that the stand or the stands (7, 8) forms/form part of a portal (5) that straddles the haulage track (6).

17. A colour code for a container and/or a container location system in accordance with any one of the preceding claims, characterized by a carrier that is designed for recording at least one specific colour or chrominance that identifies the container or several colours or chrominances identifying the container.

18. A colour code in accordance with claim 13, characterized in that the colour code is underlain by a geometric structure that consists of several sections and the sections are occupied by colours for the identification of the container and/or its contents and determining its location.

19. A colour code in accordance with claim 17 or claim 18, characterized in that each colour code is associated with a container number and that the various stations of the pool system are provided with a device for detecting the container number and are linked with the central station in such a manner that container-specific information, especially the merchandise contents or the empty state of the container and/or the containers, can be transmitted to the central station.

20. A colour code in accordance with claims 17, 18 or 19, characterized in that the colour code is designed on a carrier made of plastic material, especially a circular carrier.

21. A colour code in accordance with any one of claims 17 to 20, characterized in that the colour code surface is provided with a transparent protective layer.
